(19) United States
(12) Patent Application Publication
(10) Pub. No.: US 2004/0101463 A1
(43) Pub. Date: May 27, 2004

(54) Method for producing trichlorosilane

(76) Inventors: Andreas Bulan, Langenfeld (DE); Rainer Weber, Odenthal (DE); Hans-Dieter Block, Leverkusen (DE)

Correspondence Address: MCGLEW & TUTTLE, PC, 1 SCARBOROUGH STATION PLAZA, SCARBOROUGH, NY, 10510-0827, US

(21) Appl. No.: 10/380,140

(22) PCT Filed: Sep. 6, 2001
(86) PCT No.: PCT/EP01/10270

(30) Foreign Application Priority Data
Sep. 11, 2000 (DE) 10044794.5

(51) Int. Cl. C01B 33/107

(52) U.S. Cl. 423/342

(57) ABSTRACT

The invention relates to a method for producing trichlorosilane, whereby silicon is reacted with hydrogen, silicon tetrachloride and optionally hydrogen chloride, said silicon containing iron in the form of homogeneously distributed iron silicide.

The present invention relates to a method for producing trichlorosilane by reacting silicon with silicon tetrachloride, hydrogen and, if necessary, hydrogen chloride.

Trichlorosilane HSiCl₃ is a valuable intermediate product for producing, for example, high-purity silicon, dichlorosilane H₂SiCl₂, silane SiH₄ and bonding agents.

High-purity silicon is used versatilely for electronic and photo-voltaic purposes, e.g. in the manufacture of solar cells. To produce high-purity silicon, for example, metallurgical silicon is converted to gaseous silicon compounds, preferably trichlorosilane, these compounds being purified and subsequently reconverted to silicon.

Trichlorosilane is mainly produced by reacting silicon with hydrogen chloride, or silicon with silicon tetrachloride, hydrogen and, if necessary, hydrogen chloride (Ullmann's Encyclopedia of Industrial Chemistry, 5th ed. (1993), Vol. A24, 4-6). As a rule, silicon is reacted with silicon tetrachloride and hydrogen in the presence of catalysts, and mainly copper catalysts.

As is known from DE 41 04 422 A1, silicon is reacted with silicon tetrachloride and hydrogen in a fluidized bed without using pressure in the presence of copper salts of a low, aliphatic, saturated dicarbon acid, particularly copper oxalate.

It is also known to react silicon with silicon tetrachloride, hydrogen and, if necessary, hydrogen chloride, in the presence of powder copper (Chemical Abstracts CA 101, no. 9576d, 1984) or mixtures of copper metal, metal halogenides and bromides or iodides of iron, aluminum or vanadium (Chemical Abstracts CA 109, no. 57621b, 1988).

Although cupriferous catalysts have proved suitable in reacting silicon with silicon tetrachloride and hydrogen to trichlorosilane, the use of copper catalysts and/or cupriferous catalyst mixtures is attended by certain disadvantages.

The reaction is usually carried out in a fluidized bed (Ullmann's Encyclopedia of Industrial Chemistry, 5^{th} ed. (1993), Vol. A24, 4-6). Small silicon/catalyst particles are carried out of the fludized bed. These silicon/catalyst particles contain high concentrations of catalyst and are mostly pyrophor due to their fineness. These silicon/catalyst particles that inevitably occur must be processed and disposed of in a technical process.

As a rule, the reprocessing of such particles is expensive and cost-intensive. According to DE 195 07 602 C1 siliceous residues can be treated with hydrous alkaline solution or water. Any further use, for example as a filler or additive in the construction and/or foundry industry, is possible only after the reprocessed residues are dried and/or milled and mixed with materials containing cement and/or lime and pressed to green bodies and cured, if necessary.

Any use of the silicon/catalyst particles, for example in metallurgy, is only conditionally possible due to the high copper content. EP 786 532 A2 describes the use of siliceous residues as an admixture in the manufacture of cast iron. To this end, however, the siliceous residue must be mixed with cardboard pulp and hydraulic cement and pressed to briquettes prior to use in an expensive process.

Also the dumping of the arising silicon/catalyst particles is a problem because of the high content of the heavy metal copper. From DE 43 18 613 A1 it is known that in the case of siliceous residues containing metallic copper the copper can be eluted. In DE 43 18 613 A1 a complex way of dumping is therefore specified suggesting the joint dumping of siliceous residues together with slags from metallurgical processes. As a consequence high disposal costs arise when copper catalysts are used.

Another disadvantage is that copper catalyst is comparatively expensive. Unused catalyst is carried out of the reactor with the gas stream. This increases the amount of catalyst required since the catalyst that was carried out must be introduced into the reactor again. So the loss due to expensive catalyst being carried out causes comparatively high additional costs.

Therefore the task was to provide a method for producing trichlorosilane from silicon, hydrogen, silicon tetrachloride and, if necessary, hydrogen chloride, that is free of the above mentioned disadvantages and is characterized by a high reaction velocity and a high space-time yield respectively, particularly without using copper.

Surprisingly it was found that when using a silicon containing iron in form of iron silicide that is homogeneously distributed in the silicon, the reaction of this silicon with silicon tetrachloride, hydrogen and, if necessary, hydrogen chloride is catalysed sufficiently.

Subject-matter of the invention is therefore a method for producing trichlorosilane by reacting silicon with hydrogen, silicon tetrachloride and, if necessary, hydrogen chloride, characterized in that a silicon is used which contains homogeneously distributed iron silicide.

An essential advantage of the use of silicon according to the invention which contains homogeneously distributed iron silicide, is that silicon that is not reacted and/or carried out of the reactor and needs to be disposed of contains essentially iron as a secondary component. Since iron does not cause any environmental problems unlike copper, its elutability from the siliceous residue does not play any role, for example for storing. In addition to this, ferriferous siliceous residue is universally applicable in metallurgy which greatly facilitates its disposal and avoids dumping.

Another advantage is that the step of mixing catalyst and silicon required when using conventional catalyst is not necessary. The advantage for the production plant for the manufacture of trichlorosilane is that neither apparatuses for mixing catalyst and silicon nor silos for catalyst storage are required. This reduces investment expenditure and staff costs and enables production at low costs.

The linkage of the iron in the silicon prevents further that fine iron dust is carried out of the reactor during a reaction occurring in the fluidized bed requiring replacement of iron during the reaction, like this is the case when conventional copper catalyst is used.

Another advantage is that the significant costs for the catalyst can be reduced considerably since the very cheap catalyst iron can be introduced directly in the silicon production.

The silicon to be employed according to the invention containing homogeneously distributed iron silicide, can be produced, for example, by melting a mixture consisting of silicon and the desired amount of iron, or by adding the desired amount of iron to a silicon melt, and subsequently cooling down the melt quickly. Preferably the desired amount of iron is added already during the production of the silicon.

The quick cooling of the melt can be achieved, for example, by spraying the melt in air or by water granulation.

It is preferred to use water granulation for the quick cooling of the melted silicon and manufacture of the silicon to be employed according to the invention. For water granulation, liquid silicon is introduced into water. This allows an extremely quick cooling of the silicon. Depending on the process parameters selected, it is possible, for example, to obtain silicon pellets. Water granulation of silicon is known, for example, from EP 522 844 A2.

In this case the iron is usually provided in the silicon as finely and homogeneously distributed iron silicide.

Preferably, the silicon used has a concentration of 0.5 to 10 weight percent, particularly preferred of 1 to 5 weight percent, iron in form of homogeneously distributed iron silicide. It is also possible, however, to use silicon with a higher iron concentration.

The method according to the invention can be carried out, for example, at a pressure of 1 to 40 bar (absolute), preferably of 20 to 35 bar.

The process is carried out, for example, at temperatures from 400 to 800° C., preferably from 450 to 600° C.

The selection of the reactor for the reaction according to the invention is not critical, provided that under the reaction conditions the reactor shows adequate stability and permits the contact of the starting materials. The process can be carried out, for example, in a fixed bed reactor, a rotary tubular kiln or a fluidized-bed reactor. It is preferred to carry out the reaction in a fluidized-bed reactor.

The mol ratio of hydrogen to silicon tetrachloride in the reaction according to the invention can be for example 0.25:1 to 4:1. A mol ratio of 0.6:1 to 2:1 is preferred.

During the reaction according to the invention hydrogen chloride can be added, and the amounts of hydrogen chloride can be varied over a wide range. Preferably an amount of hydrogen chloride is added such that a mol ratio of silicon tetrachloride to hydrogen chloride of 1:0 to 1:10, particularly preferred of 1:0.5 to 1:1, is obtained.

Preferably the method according to the invention is carried out in the presence of hydrogen chloride.

In a preferred embodiment of the method according to the invention no additional catalyst, particularly no additional cupriferous catalysts is added.

Compared with a reaction using copper catalyst, the method according to the invention has comparable results with respect to yield and the time until the stationary state of the reaction is reached. Thus using the method according to the invention provides nearly the same yield, but has the said advantages compared with a method using copper catalyst.

The trichlorosilane produced according to the method according to the invention can be used, for example, for the manufacture of silane and/or hyper-pure silicon.

Therefore the invention also relates to a method for producing silane and/or hyper-pure silicon on the basis of trichlorosilane obtained according to the method specified above.

Preferably the method according to the invention is integrated into a general method for producing silane and/or hyper-pure silicon.

Particularly preferred, the method according to the invention is integrated into a multistage general method for producing hyper-pure silicon, as specified for example in “Economics of Polysilicon Process, Osaka Titanium Co., DOE/JPL 1012122 (1985), 57-78” and comprising the following steps:

a) Production of trichlorosilane;

b) Disproportionation of trichlorosilane to yield silane;

c) Purifying silane to obtain high-purity silane; and

d) Thermal decomposition of silane in a fluidized-bed reactor and depositing of hyper-pure silicon on the silicon particles which form the fluidized bed.

The method according to the invention is being explained in more detail in the following examples, without restricting the inventive idea insofar.

### EXAMPLES

### Example 1

### Comparative Example

In a reactor consisting of a glass tube with a diameter of 3 cm and a height of 18 cm and an in-built glass frit, silicon of the grain size fraction of 315-425 μm was mixed with cuprous chloride. The mixture contained 1 weight percent copper. 40 g of this mixture were heated to 500° C. and agitated by a helical ribbon impeller. A gas mixture of hydrogen and silicon tetrachloride with a mol ratio of 1.85:1 was now led through this charge from below. The gas velocity was 0.41 cm/s, with a residence time of the gas mixture in the silicon charge of 11.8 s. The reaction occurred at a pressure of 1 bar (absolute). The yield of trichlorosilane amounted to 12.4% based on the silicon tetrachloride employed. The stationary state was achieved after a period of approx. 60 min.

### Example 2

In a reactor consisting of a glass tube with a diameter of 3 cm and a height of 18 cm and an in-built glass frit, 40 g water granulated silicon of the grain size fraction of 315-425 μm and with a content of 2.3 weight percent iron were used. This silicon was heated to 500° C. and agitated by a helical ribbon impeller. A gas mixture of hydrogen and silicon tetrachloride with a mol ratio of 1.85:1 was now led through this charge from below. The gas velocity was 0.41 cm/s, with a residence time of the gas mixture in the silicon charge of 11.8 s. The reaction occurred at a pressure of 1 bar (absolute). The yield of trichlorosilane amounted to 10.8% based on the silicon tetrachloride employed. The stationary state was achieved after a period of approx. 60 min.

1. A method for producing trichlorosilane by reacting silicon with hydrogen, silicon tetrachloride and, if necessary, hydrogen chloride, characterized in that a silicon is used which contains homogeneously distributed iron silicide.

2. A method according to claim 1, characterized in that the silicon used is produced by means of water granulation.

3. A method according to at least one of claims 1 to 3, characterized in that the concentration of iron in the silicon is 0.5 to 10 weight percent.

4. A method according to at least one of claims 1 to 3, characterized in that the concentration of iron in the silicon is 1 to 5 weight percent.

5. A method according to at least one of claims 1 to 4, characterized in that the reaction is carried out at a pressure of 1 to 40 bar (absolute).

6. A method according to at least one of claims 1 to 5, characterized in that the reaction is carried out at temperatures from 400 to 800° C.

7. A method according to at least one of claims 1 to 6, characterized in that the mol ratio of hydrogen to silicon tetrachloride is 0.25:1 to 4:1.

8. A method according to at least one of claims 1 to 7, characterized in that hydrogen chloride is added when reacting silicon with silicon tetrachloride and hydrogen.

9. A method according to at least one of claims 1 to 8, characterized in that the mol ratio of silicon tetrachloride to hydrogen chloride is 1:0 to 1:10.

10. A method for producing silane and/or hyper-pure silicon, characterized in that the starting material is trichlorosilane obtained according to claims 1 to 9.
